(19) United States
(12) Patent Application Publication
(10) Pub. No.: US 2004/0022482 A1
(43) Pub. Date: Feb. 5, 2004

(54) Mem device

(76) Inventors: Paul Blair, Edinburgh (GB); Jean Podlecki, Edinburgh (GB); Scott George McMeekin, West Lothian (GB)

Correspondence Address: SUGHRUE MION, PLLC, 2100 PENNSYLVANIA AVENUE, N.W., WASHINGTON, DC, 20037, US

(21) Appl. No.: 10/362,001

(22) PCT Filed: Aug. 17, 2001
(86) PCT No.: PCT/GB01/03714

(30) Foreign Application Priority Data
Aug. 18, 2000 (GB) 002047.1
Aug. 21, 2000 (GB) 002052.2

(51) Int. Cl. G02B 6/35; G02B 6/26

(52) U.S. Cl. 385/18; 385/140

(57) ABSTRACT

Micro electro-mechanical devices, which may be formed using deep etching, and which comprise a vertical micro-mirror 14 coupled to an actuation mechanism for tilting the mirror, preferably about the vertical axis are disclosed. The mirror 14 and actuation mechanism are formed on the same substrate and thus form an integral device or chip.

Planar waveguide circuitry is proving to be a key technology in the development of the all-optical communication network. Operations such as modulation, switching and multiplexing may be performed on a single integrated optic chip that is only a few millimeters in size.

The main drawbacks of this technology are, however, the accumulated insertion loss of complex components, such as NxN switches, and the wavelength-dependent propagation times in waveguides, known as chromatic dispersion. To circumvent these drawbacks attention has recently turned to the use of ‘Free-Space’ optical circuits. This is where discrete optical components are used to form a micro-optical bench rather than using planar components connected by waveguides. Previously, free-space optical systems would have consisted of bulky optical components, such as lenses, mirrors and gratings and be unsuitable for mass integration. The development of Micro Electro-Mechanical Systems (MEMS), however, has provided the technology to enable the manufacture of complex free-space optical circuits on a single silicon chip.

MEM devices are fabricated using a process known as surface machining with sacrificial etching. In this process a thin layer of silicon oxide (the sacrificial layer) is first deposited on a silicon substrate and is followed by a layer of polysilicon. A photolithographic mask is then patterned onto the upper surface of the polysilicon which is then etched, through the mask, down to the oxide layer. The oxide layer is then etched away to leave the upper polysilicon structure free of the silicon substrate. In this manner a variety of structures can be formed such as silicon micro-cantilevers, springs, actuators and upward-facing mirrors and lenses.

To form a complex optical circuit, however, the optical axis must be parallel to the substrate. This is achieved by rotating the optical components formed by the above process into a vertical position. Typically this is accomplished through the use of hinged mechanisms, as described by Pister et al.¹. A hinge may be formed by selective etching through a double sandwich structure made of alternate layers of oxide and polysilicon. Once formed the hinged component may be rotated to the upright position by a linear actuator such as a Scratch Drive Actuator, described by Akiyama et al.². The components, when upright, are normally locked into place using subsidiary hinged plates mounted at right angles to the main component.

Careful attention must be made to the alignment and connection of different parts of these structures. Moreover, being so intricate, they are difficult to manufacture, requiring the fabrication of complex actuators whose only role is to erect the hinged components. Also the assembly elements take up valuable space leading to bulkier devices.

The present invention provides novel micro electro-mechanical devices, which may be fabricated using deep etching, and which comprise a vertical micro-mirror coupled to an actuation mechanism for tilting the mirror, preferably about a vertical axis. The mirror and actuation mechanism are formed on the same substrate and thus form an integral device or chip.

A 2×2 optical fibre switch fabricated using deep-etch vertical mirror technology has already been developed, and is described in EP 0 927 376. This switch consists of a deep etched vertical mirror mounted on a coplanar arm and positioned at 45 degrees to four fibre alignment channels. The arm is attached to an electrostatic comb drive, with the comb arrays being arranged perpendicular to the arm, for actuating a lateral movement of the mirror. Activation of the comb drive causes the mirror to move into or out of the intersection region of the fibre channels. In this manner light may be reflected from an input fibre into an orthogonal output fibre or may be allowed to pass through to the fibre directly opposite.

The present invention is defined in more detail in the appended claims to which reference should now be made. Combinations of features from the dependent claims may be combined with features of the independent claims as appropriate and not merely as explicitly set out in the claims.

An aspect of the invention provides a micro electro-mechanical device in a chip, the chip comprising a substrate, a sacrificial layer on the substrate, and a silicon layer on the sacrificial layer the micro electro-mechanical device comprising: a micro-mirror provided in the silicon layer and substantially perpendicular to a surface of the substrate on which the sacrificial is disposed; and an actuation mechanism provided in the silicon layer and coupled to the mirror, wherein the actuation mechanism is configured for tilting the mirror.

Exemplary embodiments of the present invention will be described hereinafter, by way of example only, with reference to the accompanying drawings in which Like reference signs relate to like element and in which:

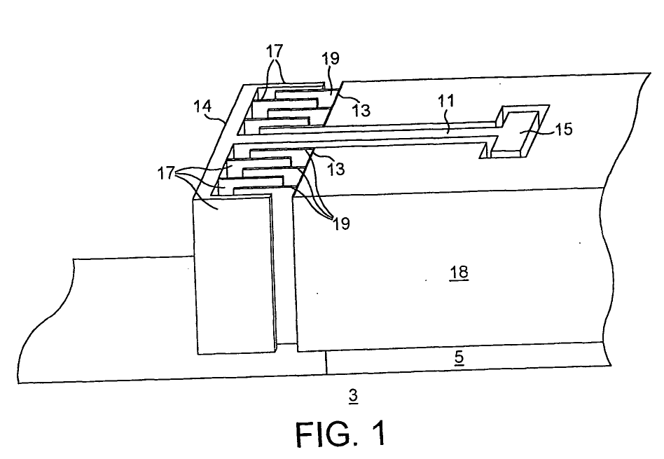

FIG. 1 shows a mirror device embodying the invention;

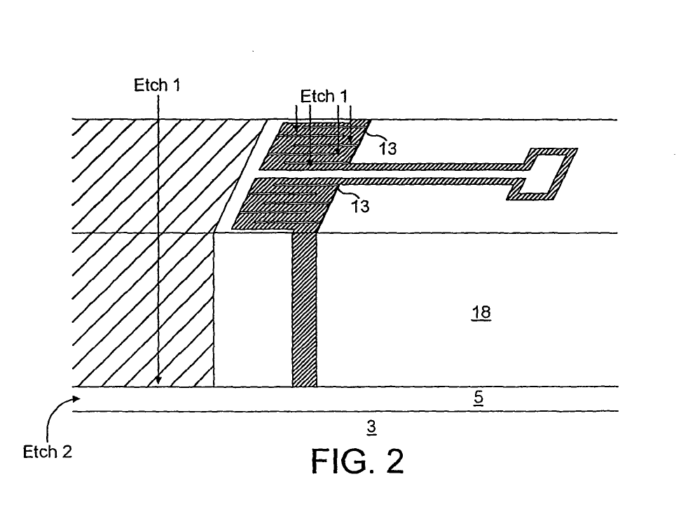

FIG. 2 shows the mirror device of FIG. 1 doing fabrication,

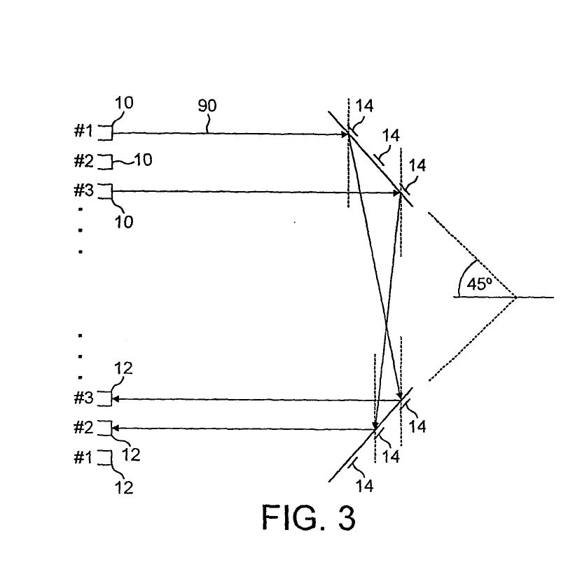

FIG. 3 shows an 8×8 optical switch embodying the invention;

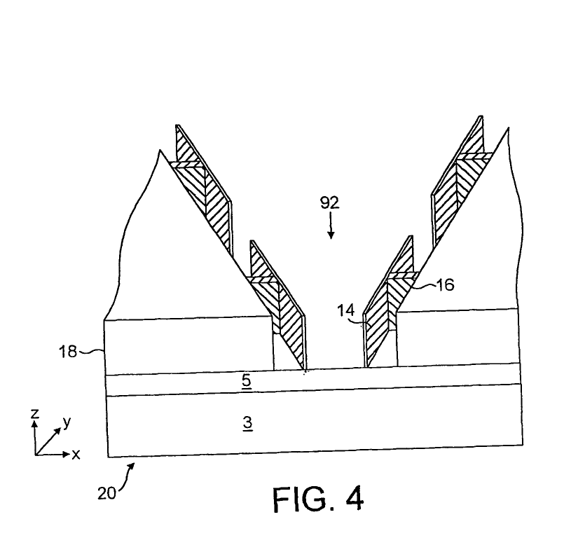

FIG. 4 is a simplified representation of a wafer during fabrication of the switch of FIG. 3;

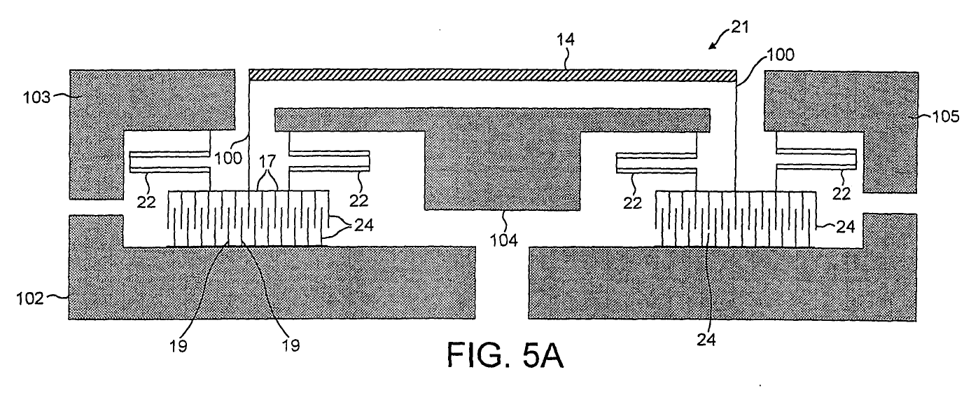

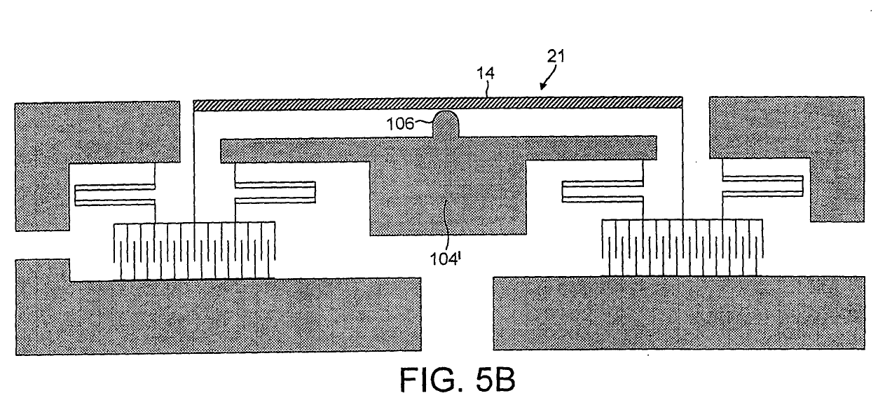

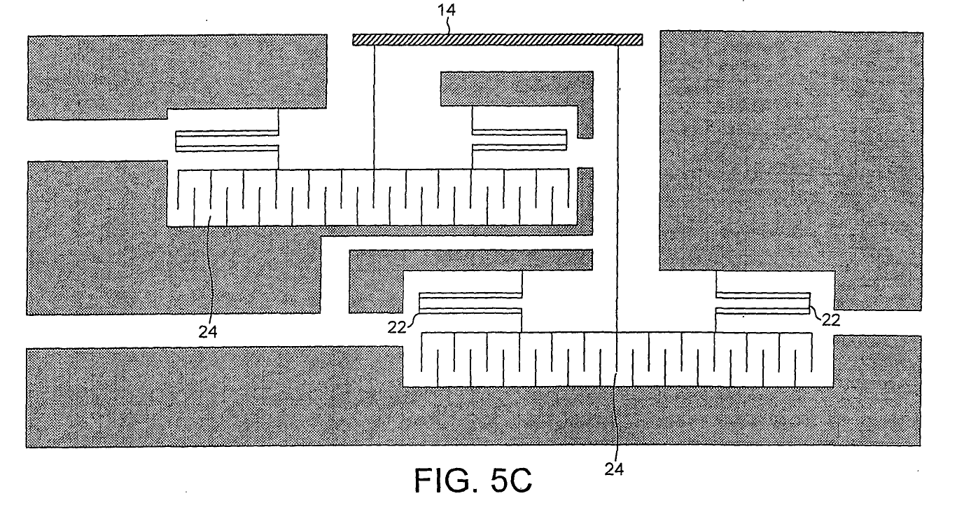

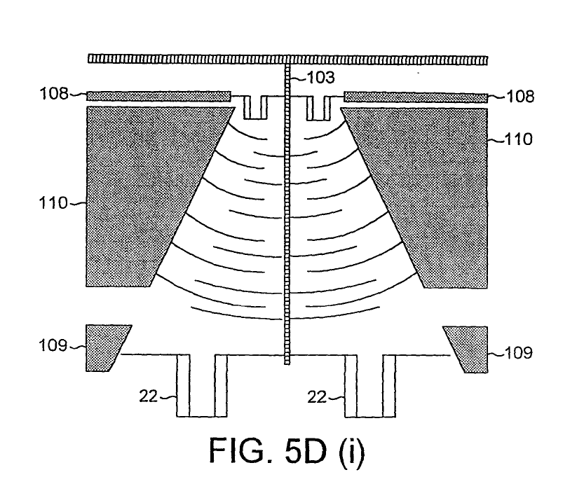

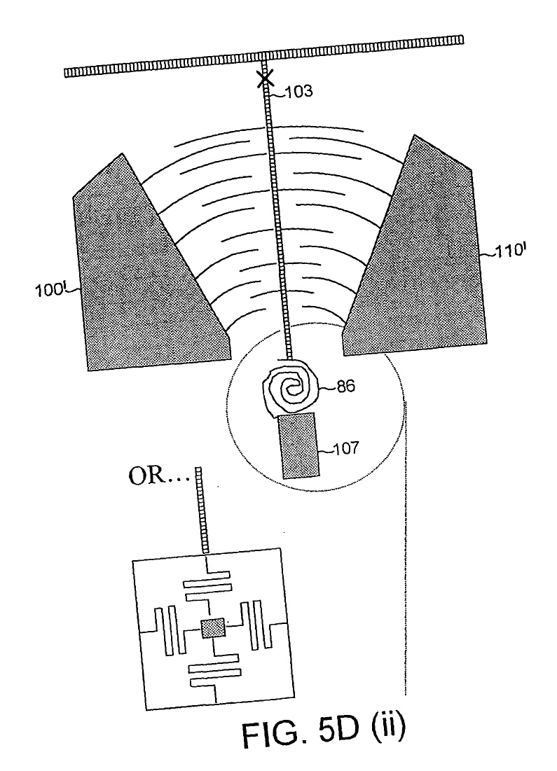

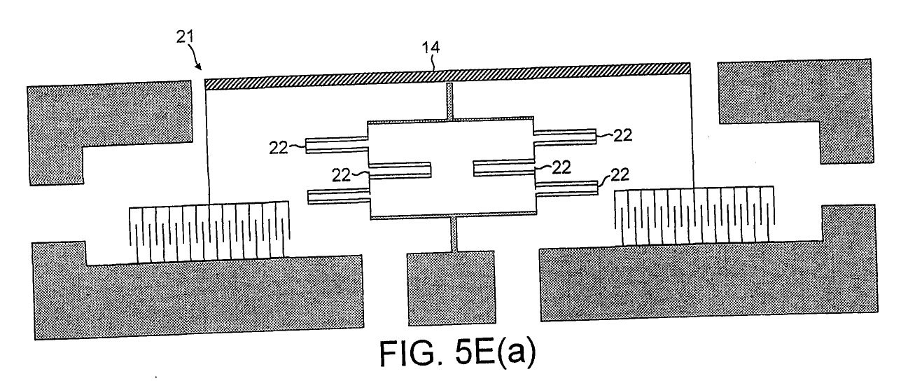

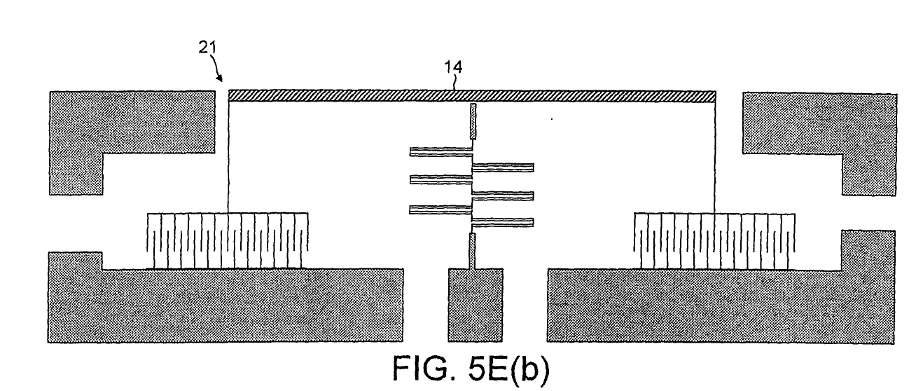

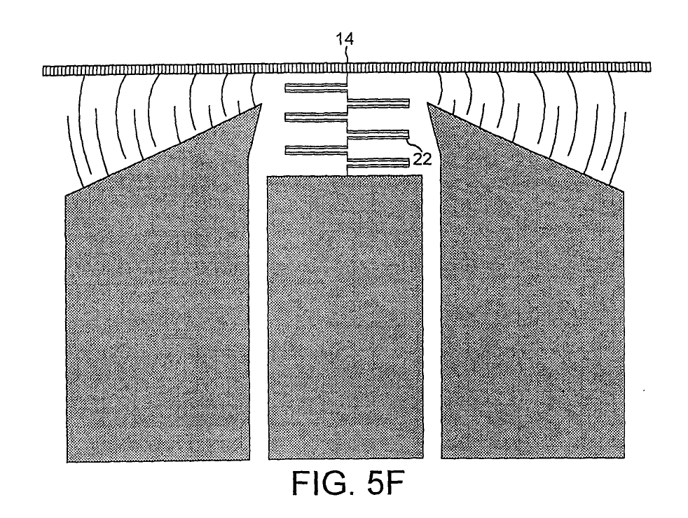

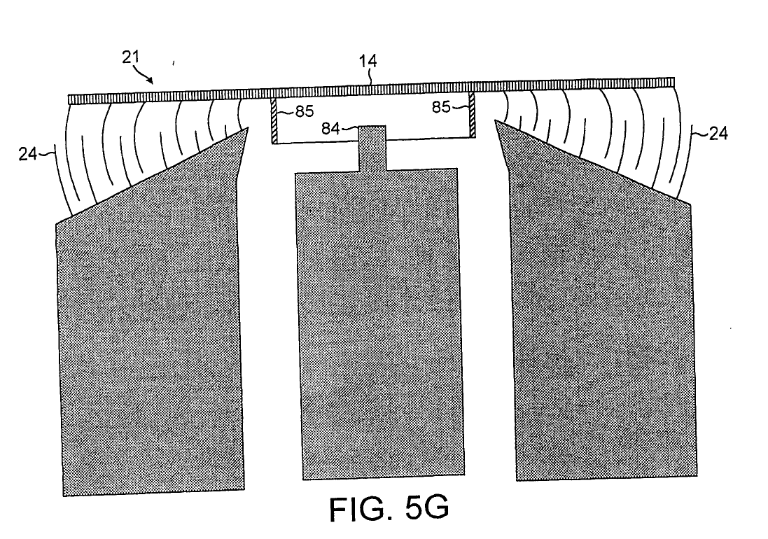

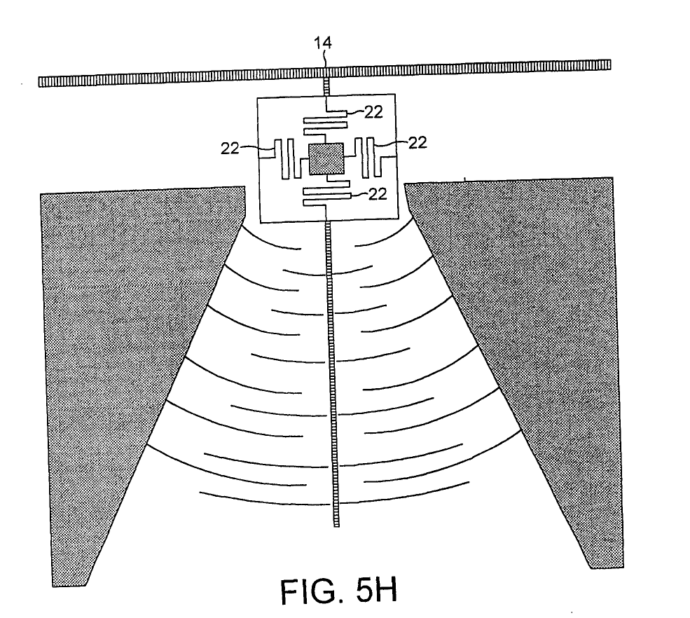

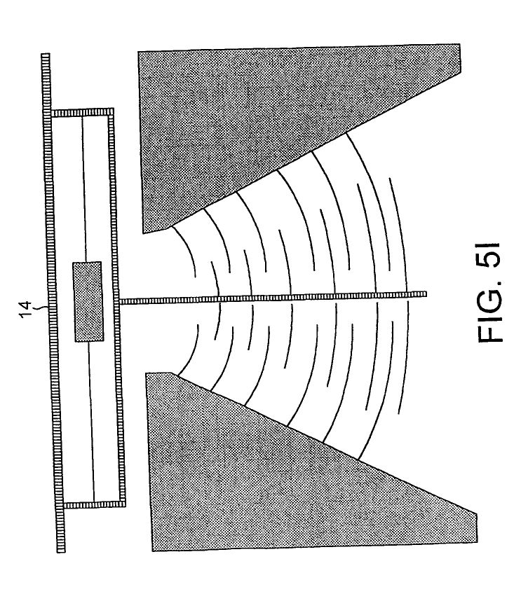

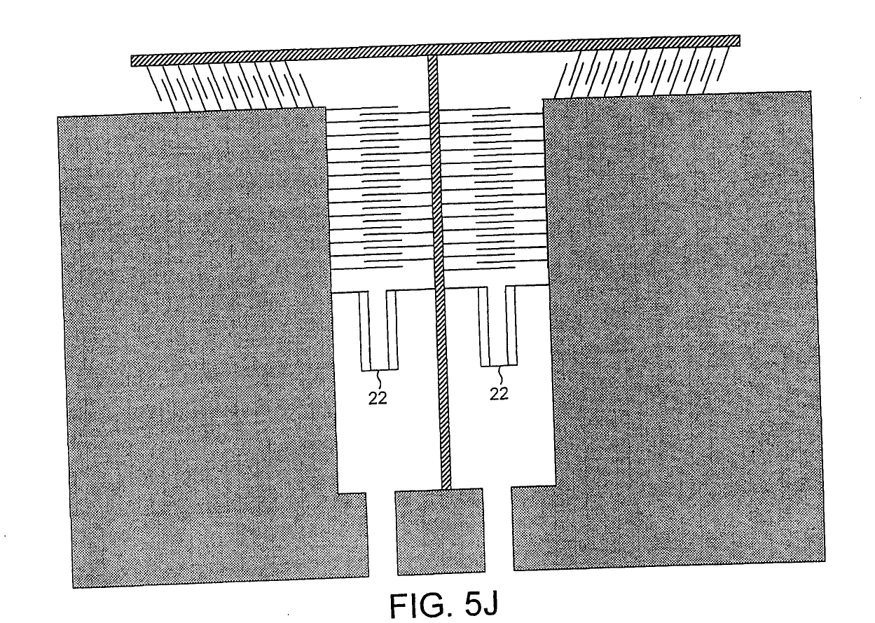

FIGS. 5A-5J show different possible arrangements of the actuation mechanism; and

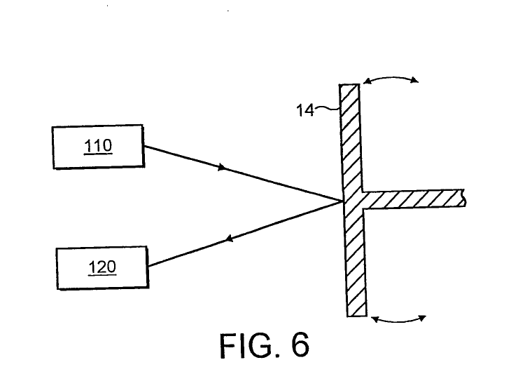

FIG. 6 shows a VOA embodying the invention.

Referring to FIG. 1 a device according to an embodiment of the invention is formed on a substrate and comprises a vertical mirror 14 connected via a spring 11 to a substrate and coupled to an actuation mechanism comprising an electrostatic comb drive. The comb drive comprises two trays of interlocking plates 17, 19, one array 17 being connected to the back of the mirror 14, and the other array 19 being connected to the substrate 13. The device also comprises electrical contacts 13 for activating the comb drive.

Referring to FIG. 2, the fabrication of the device consists of first depositing a thin layer of sacrificial oxide 5 onto a silicon substrate 3 and then depositing a layer of silicon 18, about 10-200 μm thick, onto his. A layer of photo-resist is then patterned onto the top surface of the silicon and deep reactive ion etching (DRIE) is used to etch onto the top surface of the silicon and deep reactive ion etching (DRIE) is used to etch through the shaded sections of the top silicon layer to the underlying oxide layer. This etching step includes etching to insulate the contacts from the mirror, as will be explained in more detail later with reference to FIGS. 5A-5J. The final step is to etch away the sacrificial layer under the narrower parts of the structure, such as the comb drive and the mirror, so that they are free to move with respect to the substrate. This final etch is the same in all directions, thus the slabs making up the bulk of the device will be undercut at their edges by approximately the thickness of the insulation layer, as shown in FIG. 2.

A basic 8×8 switch concept is shown in FIG. 3. The system comprises 16input/output fibres 10, 12 arranged in tow arrays. The light input from any one fibre 10 in a 1×8 input/output array can be routed to any one fibre 12 in the other 1×8 input/output array via a series of sixteen micro-mirrors 14 (approximately tens to hundreds of microns in size). For example, arrow 90 shows light input via input fibre 1 being routed to output fibre 3. The mirrors are distributed in two 1×8 arrays. The two mirror planes subtend an angle of 90 degrees. Each mirror can be rotated by electrostatic actuation through a (approximately)±10 degree range in order to route the optical signal between fibres. The configuration shown in FIG. 3 is favoured as it provides a through-routing in the event of power failure.

The switch may be fabricated in a single thick SOI (Silicon-On-Insulator) wafer with the majority of the switch fabricated in a single mask and etch step; the mask describing the plan elevation of the system (i.e. the view of FIG. 3). The switch (basic geometry, all mirrors, springs, actuators, supports, etc.) being created in the upper Si layer 18 of the SOI wafer 20 (see FIG. 4).

FIG. 4 is a simplified representation of the wafer, (comb drives not shown), before the hashed areas (mirrors 14 and supports 16) are released, by the removal of the SiO2 sacrificial layer 5. Actuation would most likely be by electrostatic comb drive, for example using one of the arrangements shown in FIGS. 5A-5J, which comprises a pair of fixed combs and a pair of movable combs. The position of the movable combs is controlled by applying a voltage between the fixed and movable sets of combs. A few micron of movement can readily be obtained. The optical coupling between input/output fibre arrays is managed via lens pairs (not shown) positioned in front of each fibre (the light is imaged between fibre planes, with the focal point in the centre of system). Arrow 92 shows the direction of etch.

FIGS. 5A-5J show plan views of various modified arrangements of the actuation mechanism. Like symbols and reference numerals are used for like structures, and filled-in areas represent fixed regions rather than those which have been released by etching of the sacrificial layer.

In summary, FIG. 5J shows comb drive mounted within trench attached to armature (possibly a curved structure unlike the straight structure shown) or attached to the mirror underside (comb could point in either direction). Optional restoring springs may be attached above or below the comb drive. The actuation mechanism shown in FIG. 5J is closest to that of FIGS. 1 and 2. It comprises a comb drive attached to the back of the mirror, as in the arrangement of FIGS. 1 and 2. Additionally, there is a trench arranged around the armature on which the mirror is mounted, and extra comb drives are provided between either side of the armature and the adjacent slabs. These provide a lateral force on the armature of the mirror providing an extra tilting force. A pair of flexure elements, such as springs, 22, is arranged, one between each side of the armature and the adjacent slab, to provide restoring forces.

FIG. 5A shows the MEMS device 21 in which the mirror 14 is attached to two comb drives 24 by two plates 100 attached perpendicular to the mirror at its ends. Each plate 100 mounts a first array of a comb drive 17 with the second, partnering comb arrays being supported on adjacent slab structures. Electrostatic attraction between a selected pair of comb arrays will pull the associated end of the mirror into the device, thereby tilting the mirror. The first comb arrays are coupled via springs to fixed slab portions 103, 104, 105, of the device, which springs provide restoring force when the electrostatic force stops. FIG. 5B shows a modification of the device of FIG. 5A, in which the slab portion 104′ behind the mirror is etched to include a ridge 106 which acts as a pivot for the mirror and prevents it from being drawn into the device, thereby improving the tilting action of the mirror.

FIG. 5C shows a modification which allows the device to be narrower, so that mirrors can be arranged more closely together in an array. In particular, it minimises the separation between mirrors if long comb drives are necessary. This is achieved by staggering, and overlapping the comb drives, one being arranged further back than the other.

FIG. 5D shows three arrangements in which the mirror is mounted centrally on a perpendicular shaft or plate 103. The plate is coupled via spring arrangements to slab portions 107,108, 109 of the device. A first curved comb arrays are mounted on the plate, with partnering second comb array being mounted on different slab regions 110,100′. In FIG. 5Dii a spiral spring 86 is shown. Alternatively this may be a square arrangement comprising four springs as shown in the inset. A further modification is that the spring arrangement could be alternatively positioned at the other end of the plate, that is be inserted at the position marked ‘X’ (for example as shown in FIG. 5H). In this case the armature would connect to the bottom of the frame and the mirror shaft to the top.

FIGS. 5E to 5I show further modifications which are considered self-explanatory. In FIG. 5G, supports 85 are shown on either side of rotation axis 84.

In some modifications the comb drives comprise straight plates (e.g. in FIGS. 5A-5C, 5E and 5J). In other arrangements the comb drives preferably comprise curved plates 24 as shown in FIGS. 5D, 5F, to 5I.

To increase the reflectivity of the vertical mirror the silicon is coated with a thin layer of aluminium, gold or diamond using chemical vapour deposition. During this process the sample may be appropriately angled to allow the vapour to reach the vertical surfaces.

In another embodiment of the invention, a Variable Optical Attenuator (VOA) is provided as shown in FIG. 6. This VOA comprises two optical waveguides 110, 120 and a tiltable mirro 14 connected to an actuation mechanism (not shown). Light omitted from input waveguide 110 is reflected by the mirror to waveguide 120. By tilting the mirror the amount of light reaching output waveguide 120 is altered, thus providing attenuation of the signal. This can be controlled and varied by controlling and varying the angle of tilt of the mirror.

Other applications of tiltable mirrors according to the invention include sensors and actuators.

The main advantages of the DRIE process to fabricate vertical mirrors is that it is basically a one-step process. The mirror and the comb drive are manufactured by a single etching step followed by a release etch.

The fabrication of vertical micro-mirrors in silicon by deep-etching is a single step process and avoids the complications of having to rotate surface-machined components to an upright position. Alignment problems are also avoided, as no assembly steps are required. Also no space need be taken up by assembly elements, which means that the devices which can be made even smaller.

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

### REFERENCES

¹ K. S. J. PISTER et al., “Microfabricated hinges”, Sensors and Actuators A, vol.33, pp249-256, 1992.

² T. AKIYAMA et al., “Scratch drive actuator with mechanical links for self-assemble of three-dimensional MEMS”, Journal of Microelectromechanical Systems, vol.6, pp10-17, 1997.

1. A micro electro-mechanical device in a chip, the chip comprising a substrate, a sacrificial layer on the substrate, and a silicon layer on the sacrificial layer, the micro electro-mechanical device comprising:
a micro-mirror provided in the silicon layer and substantially perpendicular to a surface of the substrate on which the sacrificial layer is disposed; and
a actuation mechanism provided in the silicon layer and coupled to the mirror, wherein the actuation mechanism is configured for tilting the mirror.

2. A device according to claim 1, in which the actuation mechanism tilts the mirror about an axis, substantially perpendicular to the substrate.

3. A device according to claims 1 or 2 in which the mirror is substantially vertical.

4. A device according to any preceding claim in which the actuation mechanism is connected to the back of the mirror.

5. A device according to any preceding claim, comprising a support member attached to the mirror.

6. A device according to any preceding claim, in which the actuation mechanism comprises at least one comb drive.

7. A device according to claim 6, in which said comb drive comprises a pair of curved combs.

8. A switch comprising at least one device according to any of claims 1 to 7.

9. A variable optical attenuator comprising at least one device according to any of claim 1 to 7.

10. A method of fabricating a micro electro-mechanical device comprising providing a silicon-on-insulator (SOI) wafer, forming a mirror and actuation mechanism in the upper silicon layer, the mirror being substantially perpendicular to the surface of the silicon substrate of the SOI wafer on which an insulation layer is disposed; and etching away the insulation layer to release the mirror and at lest part of the actuation mechanism from the silicon substrate; wherein the actuation mechanism is configured to provide a tilting force to the mirror.

11. A method according to claim 10, in which the actuation mechanism is coupled to the back of the mirror.

12. A method according to claim 10 or 11 further comprising the step of coating the mirror with gold, diamond or aluminium.

13. A micro electro-mechanical device substantially as described herein with reference to the drawings.

14. An integral chip substantially as described herein with reference to the drawings.

15. A switch substantially as described herein with reference to the drawings.

16. A VOA substantially as herein described with reference to the drawings.

17. A method of manufacturing a micro electro-mechanical device substantially as described herein.
